(19) United States
(12) Patent Application Publication
(10) Pub. No.: US 2008/0280556 A1
(43) Pub. Date: Nov. 13, 2008

(54) CONTROL METHOD FOR A WIRELESS AUDIO/VIDEO SYSTEM

(75) Inventor: WEI-CHIN HUANG, Sanchong City (TW)

Correspondence Address: WEI-CHIN HUANG, P.O.BOX 108-00403, Taipei, 106, omitted

(73) Assignee: WEI-CHIN HUANG, Sanchong City (TW)

(21) Appl. No.: 12/116,944

(22) Filed: May 7, 2008

(30) Foreign Application Priority Data
May 8, 2007 (TW) 096116345

(51) Int. Cl. H04H 40/00

(52) U.S. Cl. 455/3.06

(57) ABSTRACT

A control method for a wireless audio/video system is disclosed. The control method is used for detecting whether a wireless receiving module receives an invalid signal by an error detection module in an audio/video player and thereby prevents the audio/video player from unable to receive or play the audio/video signal or other programs normally. Furthermore, the audio/video player of the present invention has a button controlling module and a wireless transmission module for operating with a wireless receiving module and a wireless transmission module of a fore end controlling device to substantially achieve bidirectional communication for the wireless audio/video device.

This application claims the priority benefit of Taiwan patent application number 096116345 filed on May 8, 2007.

### BACKGROUND OF THE INVENTION

1. Field of the Invention

The present invention relates to a control method for a wireless audio/video system and more particularly, to a control method for detecting whether the wireless receiving module receives an invalid signal by the error detection module in the audio/video player and thereby prevents the audio/video system from unable to receive or play the audio/video signal or other programs normally. Furthermore, the audio/video system of the present invention has a button controlling module and a wireless transmission module for operating with a wireless receiving module and a wireless transmission module of a fore end controlling device to substantially achieve bidirectional communication for the wireless audio/video system.

2. Description of Related Art

Recalling the television history to understand that the television has been improved from the black-white CRT TV to color CRT TV, and then to the latest LCD TV and the plasma TV. The display effect is also being upgraded to higher quality, better contrast and more outstanding color and brightness. In addition, the number of the channels is also increased from few to more than a hundred, and the transmission method is also upgraded from analog to the digital.

The available TV signal regardless of analog signal or digital signal has to be displayed or played in a particular mode, for example, the TV monitor is connected to a signal receiver/transmitter through a signal cable for displaying and outputting. The computer monitor has to be connected to a computer host for displaying. The computer monitor nowadays can display signals received via Internet from far remote location, as well as display the online video images through the cyber camera.

Furthermore, the multimedia player enables the users to receive the multimedia information from anywhere and at anytime, for example, the commercial wall-display of the department store or the mall for stimulating the consumer behavior. Recently, the wireless transmission technology has been used for audio and video signal transmission, and the method thereof is used to transmit signals from a rear end host (for example, a DVD player or a computer) to a controller (for example a TV box or a signal box) to further transmit to a displaying device for displaying via a built-in wireless radio module. Thus, there is no need to connect to the external wire for the signal transmission.

However, in spite of the wiring cost reduction for the above wireless transmission and the surrounding environment can be improved thereby, there are still following defects:

1. The user or manager is unable to switch from the display terminal, thus if the manager finds out that the program or advertisement can't be normally played, the trouble has to be eliminated through the communication with the control room by the telephone or radio, and it is not effective for management in such one-way audio/video system control.

2. If the manager does not find out the error on time, the blank channel will cause loss since the program cannot be displayed in the paid channel.

Therefore, how to overcome the above conventional defects is an important issue for the manufacturers in the field.

### SUMMARY OF THE INVENTION

An object of the present invention is to provide a control method for a wireless audio/video system, which is capable of overcoming the defects of the conventional method described above.

The present invention comprises an error detection module in an audio/video player for detecting whether any invalid signal is received by a wireless receiving module to further judge whether the audio/video player receives or plays the audio/video signal or other programs. The present invention enables the audio/video player to switch a valid channel automatically even when the manager cannot notice it on time, and therefore prevent economic loss.

According to another aspect of the present invention, the audio/video player comprises a key control module and a wireless transmission module to enable the manager to reset or eliminate trouble by processing at the fore end controlling device without going through the control room, thus resolve the defects of the conventional one-way controlling method by applying the bidirectional controlling method of the present invention.

### BRIEF DESCRIPTION OF THE DRAWING

FIG. 1 is a block diagram of a wireless audio/video system according to an embodiment of the present invention.

FIG. 2 is a block diagram of an audio/video player of the wireless audio/video system according to an embodiment of the present invention.

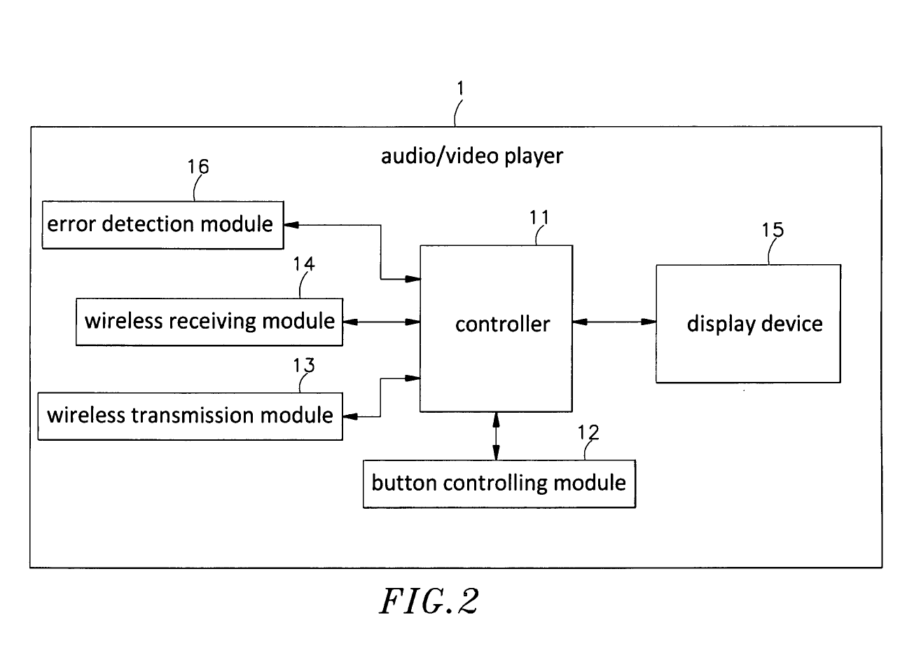

FIG. 3 is a block diagram of a fore end controlling device of the wireless audio/video system according to an embodiment of the present invention.

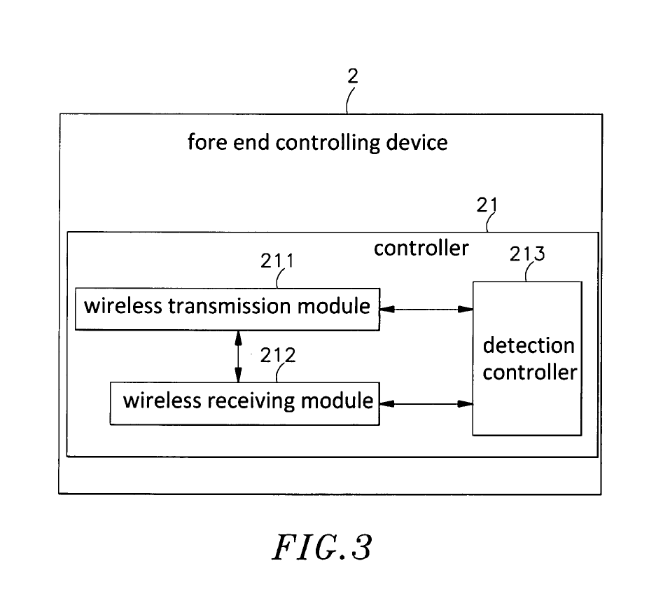

FIG. 4 is a process flow chart of the wireless audio/video system according to an embodiment of the present invention.

### DETAIL DESCRIPTION OF THE INVENTION

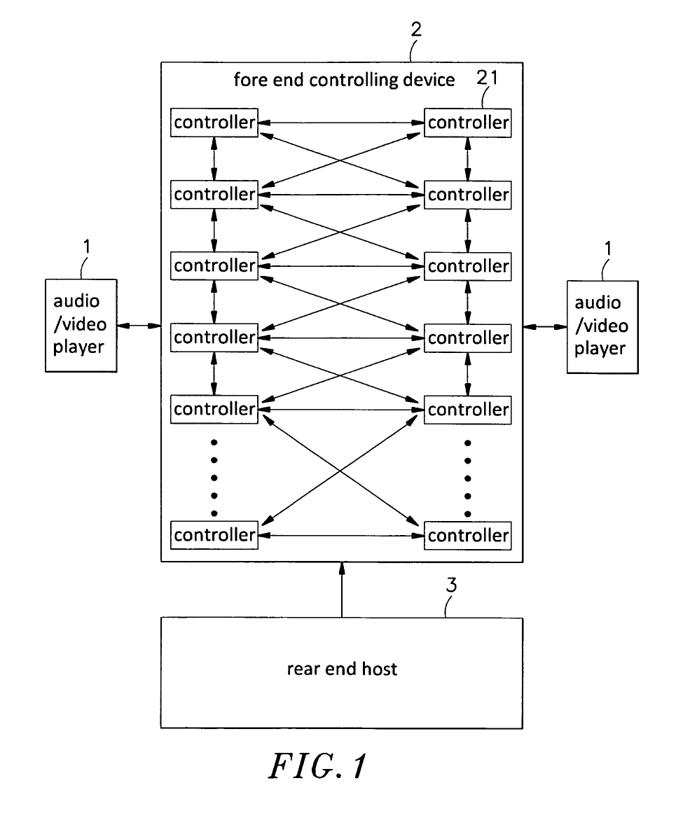

Referring to FIGS. 1˜3, a wireless audio/video system in accordance with the present invention is shown comprised of an audio/video player 1, a fore end controlling device 2 and a rear end host 3.

The audio/video player 1 comprises a controller 11, a button controlling module 12, a wireless transmission module 13, a wireless receiving module 14, a display device 15 and an error detection module 16. The controller 11 is a control unit in the audio/video player 1 and respectively electrically connected to the button controlling module 12, the wireless transmission module 13, the wireless receiving module 14, the display device 15 and the error detection module 16 as a connection controlling interface. The button controlling module 12 can receive a command from a user, for instance, the user can issue a controlling command through an external remote controller or pressing the button directly for switching the channel or adjusting the volume. The wireless transmission module 13 is used for transmitting the user's command. The wireless receiving module 14 is used for receiving an external TV or audio/video signal. The display device 15 is used for playing the TV or audio/video signal received by the wireless receiving module 14. Furthermore, the error detection module 16 is used for judging whether the audio/video signal received by the audio/video player 1 is correct.

The fore end controlling device 2 comprises a plurality of the controllers 21. Each controller 21 comprises a wireless transmission module 211 for transmitting an audio/video signal, a wireless receiving module 212 for receiving the signals transmitted from the wireless receiving module 14 of the audio/video player 1, and a detection controller 213 for judging whether the signals received by the controller 21 is correct.

The rear end host 3 can be DVD, VCD, MP3 or other multimedia players, or computer, game player or stereo system.

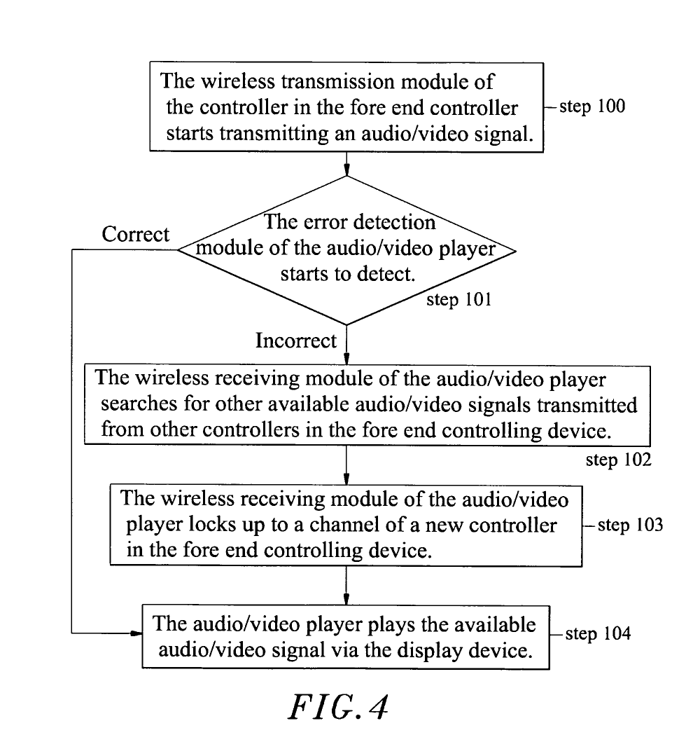

Accordingly, after connecting the fore end controlling device 2 to the rear end host 3, the wireless transmission between the audio/video player 1 and the fore end controlling device 2 can substantially accomplish the main structure of the wireless audio/video system of the present invention. The general playing method according to the present invention includes transmitting an audio/video signal (for example, the advertisement or the TV program) from the rear end host 3 to the fore end controlling device 2, and then further transmitting the audio/video signal wirelessly from the controller 21 of the fore end controlling device 2 to the corresponding audio/video player 1 for playing. However, if the audio/video player 1 cannot function normally for playing, the user may use the following procedure as illustrated in FIG. 4, to achieve bidirectional communication or control.

At step 100, the wireless transmission module 211 of the controller 21 in the fore end controlling device 2 starts to transmit an audio/video signal.

At step 101, the error detection module 16 of the audio/video player 1 starts to detect, and the procedure proceeds to step 104 if there is no error occurred.

At step 102, the wireless receiving module 14 of the audio/video player 1 searches for other available audio/video signals transmitted from other controllers 21 in the fore end controlling device 2.

At step 103, the wireless receiving module 14 of the audio/video player 1 locks up to a channel of a new controller 21 in the fore end controlling device 2.

At step 104, the audio/video player 1 plays the available audio/video signal via the display device 15.

The control method described above is employed to detect whether the wireless receiving module 14 receives an invalid signal by the error detecting module 16 in the audio/video player 1 to prevent the audio/video player 1 from unable to receive or to play the audio/video signal or other programs normally. Furthermore, there are three methods to search for the available audio/video signal transmitted from other controllers 21 in the fore end controlling device 2 in step 102. The first method includes searching according to the intensity of the signal transmitted by other controllers 21 in the fore end controlling device 2. The second method includes searching according to the transmission route length of the audio/video signal within the fore end controlling device 2. The third method includes searching according to the matching between the channel of the wireless transmission module 13 in the audio/video player 1 with the channel of the wireless transmission module 211 of the other controllers 21 in the fore end controlling device 2. The above methods enable the wireless audio/video player 1 of the present invention to play the received available audio/video signals through the display device 15. Furthermore, when the error detecting module 16 of the audio/video player 1 detects the error occurred, the controller 11 will report to a far end controller; meanwhile, the user or manager can directly select or assign a new available controller 21 in the fore end controlling device 2 through the button controlling module 12 and the wireless transmission module 13 of the audio/video player 1. Similarly, the error detection controller 213 of the controller 21 in the fore end controlling device 2 can also detect whether the controller 21 transmits or receives an invalid audio/video signal.

In addition, referring to FIG. 1 again, the audio/video player 1 can be connected to a single controller 21 of the fore end controlling device 2, or the audio/video player 1 can also be connected to a plurality of the controllers 21 of the fore end controlling device 2. Furthermore, the plurality of controllers 21 in the fore end controlling device 2 can be connected to each other, and the audio/video signal can be transmitted via different controllers 21 to the audio/video player 1.

Therefore, the control method for the wireless audio/video system according to the present invention has the following advantages:

1. The error detection module 16 in the audio/video player 1 can be used to detect whether the wireless receiving module 14 receives an invalid signal to further judge whether the audio/video player 1 can function normally for playing. The control method of the present invention enables the audio/video player 1 to automatically switch the channel to an available channel even without being controlled by the manager. Thus, the display device 15 of the audio/video player 1 won't be blank at anytime.

2. The button controlling module 12 and the wireless transmission module 13 of the audio/video player 1 enables the manager to directly reset or eliminate trouble without processing through the control room once it is found out that the program or advertisement is not being normally played. Thus, the control method of the present invention effectively resolves the defect of the conventional art described above.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

What the invention claimed is:

1. A control method for a wireless audio/video system comprising an audio/video player, a fore end controlling device and a rear end host, the method comprising:
(a) transmitting an audio/video signal by using a wireless transmission module of a controller in said fore end controlling device;
(b) starting to detect by using an error detection module of said audio/video player, and proceeding to step (e) if no error is detected;
(c) searching for other available audio/video signals transmitted from other controllers in said fore end controlling device by using a wireless receiving module of said audio/video player;
(d) locking up to a channel of a new controller in said fore end controlling device by using said wireless receiving module of said audio/video player; and
(e) playing said available audio/video signal via a display device of said audio/video player.

2. The control method for the wireless audio/video system according to claim 1, wherein said other available audio/video signals in step (c) is searched according to an intensity of said audio/video signals.

3. The control method for the wireless audio/video system according to claim 1, wherein said other available audio/video signals in step (c) is searched according to a transmission route length of said audio/video signal.

4. The control method for the wireless audio/video system according to claim 1, wherein said other available audio/video signals in step (c) is searched according to whether a channel in said wireless transmission module of said audio/video player matches with a channel in said wireless transmission module of other controllers in said fore end controlling device.

5. The control method for the wireless audio/video system according to claim 1, wherein said fore end controlling device comprises a plurality of controllers connected to one another, and said audio/video signal is transmitted by different controllers to said audio/video player.

6. The control method for the wireless audio/video system according to claim 1, wherein said control method is directly controlled by operating a button controlling module in said audio/video player.
